(19) United States
(12) Patent Application Publication
(10) Pub. No.: US 2005/0009587 A1
(43) Pub. Date: Jan. 13, 2005

(54) Cover replacement assembly for a mobile communication terminal

(75) Inventor: Sang-Hyun Lee, Gyeonggi-Do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/845,393

(22) Filed: May 12, 2004

(30) Foreign Application Priority Data
May 12, 2003 (KR) 2003-29911

(51) Int. Cl. H04Q 7/20

(52) U.S. Cl. 455/575.8; 455/550.1; 455/575.3

(57) ABSTRACT

Disclosed is a cover replacement assembly for a mobile communication terminal, wherein a replaceable cover is detachably secured to a frame coupled to the terminal. The cover and frame are formed with locking means that snap fit. Locking members formed on the cover engage a locking sill formed on the frame. Also, locking element that is inserted into an aperture in the frame can be manipulated in order to detach the cover from the frame and terminal.

### CROSS-REFERENCE TO RELATED APPLICATIONS

Pursuant to 35 U.S.C. § 119(a), this application claims the benefit of earlier filing date and right of priority to the Korean Patent Application No. 2003-29911, filed on May 12, 2003, the content of which is hereby incorporated by reference in its entirety.

### BACKGROUND OF THE INVENTION

1. Field of the Invention

The present invention relates to a mobile communication terminal, and, more particularly, to a cover replacement assembly for a mobile communication terminal.

2. Description of Related Art

A mobile communication terminal (hereinafter, referred to as ‘terminal’) is a portable device by which voice, message and image information can be transmitted/received through a wireless medium. Recently, terminals having multimedia function besides the simple voice transmitting/receiving function are being developed.

As mobile communication service and manufacturing technology improve, terminals have become smaller in size. Furthermore, many terminals are now constructed as a folding type mobile terminal, which offers the advantages of larger display screens and better ergonomics with respect to use and portability. Currently, many terminals, including the folding-type, utilize larger liquid crystal display (LCD) screens for display purposes, larger and more power circuitry for operations, and peripherals for alternative uses, such as digital photography.

In order to protect these elements, terminals must be constructed of materials having greater structural integrity. However, such materials increase the manufacturing costs of the terminals. In balancing costs, materials such as high grade polymers have been used to construct the casing for mobile terminals. Unfortunately, such casings are highly susceptible to scratches and cracking from physical impact, and environmental damage due to exposure.

Alternative solutions have been provided in the form of polymer covers that snap fit to the casings of the terminals. However, such covers serve a more cosmetic purpose and often detach from the terminal after physical impact. Furthermore, these plastic covers add weight and volume to the terminals, which manufacturers are currently striving to make smaller.

Accordingly, there is a need for a smaller and reliable cover, which can be replaced in case of damage and which does not detract from the ergonomics and cosmetics of the terminal.

### SUMMARY OF THE INVENTION

The present invention is directed to a cover replacement assembly for a mobile communication terminal that substantially obviates one or more problems due to limitations and disadvantages of the related art above.

An object of the present invention is to provide a cover replacement assembly for a mobile communication terminal that would not deform and sufficiently tolerate impacts applied to the terminal.

Another object of the present invention is to provide a cover replacement assembly having lower manufacturing costs and that would facilitate customization of mobile terminals.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a cover assembly for a mobile communication terminal, the assembly comprising a frame coupled to the terminal, wherein the frame comprises a locking sill, and a locking aperture. The assembly also comprises a cover detachably secured to the folder frame, wherein the cover comprises a locking element to engage the locking aperture, and at least one locking member to engage the locking sill.

According to one aspect of the present invention, the at least one locking member engages the locking sill via snap fit.

According to another aspect of the present invention, the at least one locking member is formed on a lateral edge of the cover and the locking sill is formed on an inner surface of the frame. Also, the at least one locking member and the locking sill each may comprise a protruding groove so that the protruding groove of the locking member opposes the protruding groove of the locking sill, whereby the protruding grooves of the locking member and the locking sill tightly engage each other in a locking relationship.

According to another aspect of the present invention, the locking element may comprise a hook portion that is inserted into the locking aperture when the cover is detachably secured to the frame. Also, the locking aperture may comprise an external cross-sectional area to allow contact with the locking element so that the locking element disengages the aperture. Furthermore, the locking aperture and the locking element may be formed on corresponding distal ends of the frame and the cover, respectively.

It is to be understood that both the foregoing general description and the following detailed description are exemplary and explanatory and are intended to further describe the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 illustrates a perspective view of a cover replacement assembly, in accordance with an embodiment of the present invention, disposed on a folding member of a folding-type mobile communication terminal;

FIG. 2 illustrates a perspective view of a cover replacement assembly, in accordance with an embodiment of the present invention, detached from a folding member of a folding-type mobile communication terminal;

FIG. 3 illustrates a cross sectional view of the folding member along line A-A′ in FIG. 1;

FIG. 4 illustrates a cross sectional view of the folding member along line B-B′ in FIG. 1; and

FIG. 5 illustrates an enlarged view of the encircled locking unit in FIG. 3;

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

Reference will now be made in detail to one or more embodiments of the invention, examples of which are illustrated in the accompanying drawings.

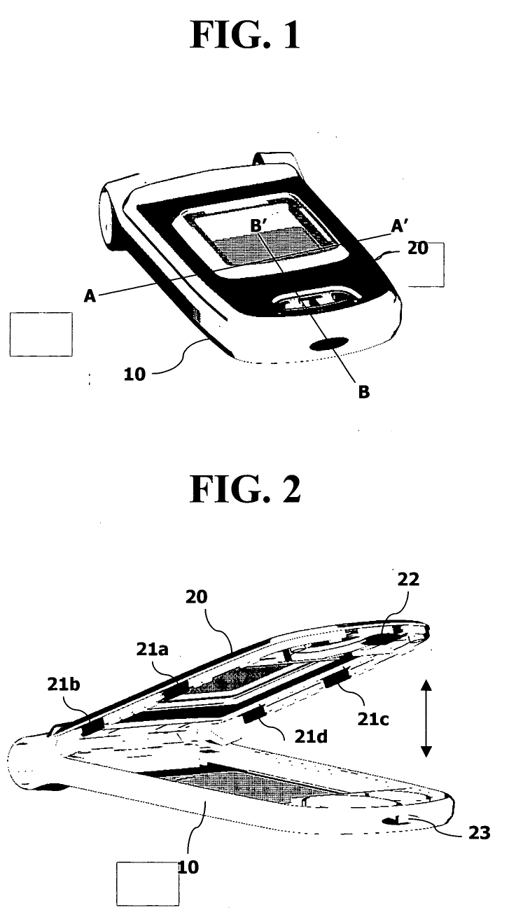

Referring to FIG. 1, a perspective view of a cover replacement assembly, disposed on a folding member of a folding-type mobile communication terminal, is illustrated in accordance with an embodiment of the present invention. In FIG. 1, a replaceable cover 20 is disposed on a folding member of a folding type mobile communication terminal, wherein the cover 20 is fastened to a terminal member frame 10 of the terminal's folding member. The terminal member frame 10 is exemplified here as comprising a hinge housing, wherein the folding member is rotatively coupled to a second folding member of the terminal. A cover replacement assembly according to an embodiment of the present invention is also applicable to the second folding member as well as candy bar type terminals. Preferably, the cover 20 fastens to the terminal frame 10 via snap fit, although other fastening means known to one of ordinary skill in the art can be applied. Also, the cover 20 comprises a predetermined locking means for smooth locking to the folder frame 10.

In FIG. 2, the replaceable cover 20 is shown to be detached from the terminal member frame 10. Locking members 21a-21d are formed at a lateral side of the cover 20. Preferably, the locking members 21a-21d are paired and formed at opposing lateral sides of the cover 20. A locking element 22 is preferably formed on a distal end of the cover 20 and engages an aperture 23 formed on a corresponding distal end of the frame 10. The locking element is preferably hook shaped so that the hook portion of the locking element 22 is inserted into the aperture 23, thereby securing the assembly 20 to the frame 10. In FIG. 2, the hook portion of the locking element 22 is exemplified as “L” shaped. Also, the cross sectional area of the aperture 23 is predetermined and preferably sufficient to facilitate a user to press on the horizontal portion of the locking element 22 through the aperture 23 with his or her finger, thereby disengaging the element 22 from the aperture 23.

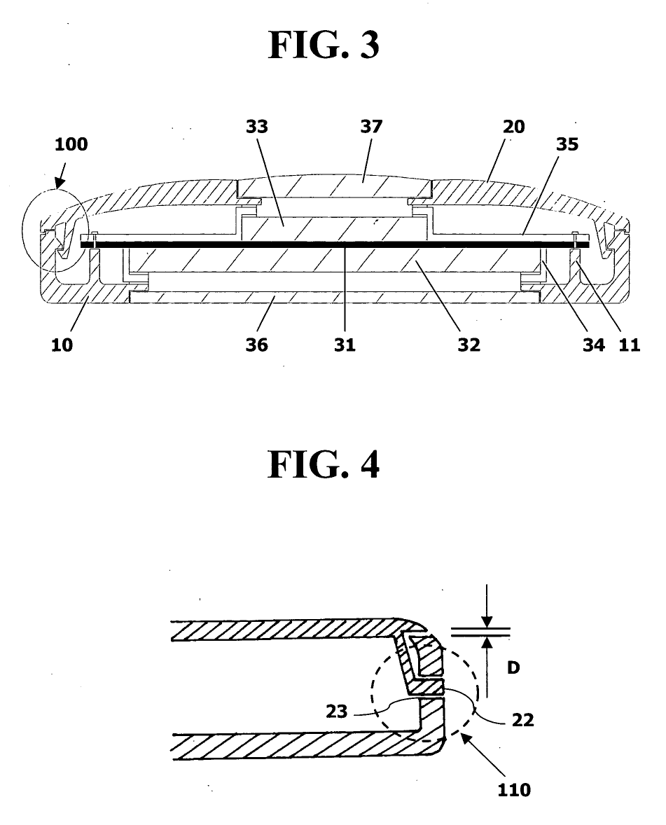

Referring to FIG. 3, a cross sectional view of the folding member along line A-A′ in FIG. 1 is shown, wherein a printed circuit board (PCB) 31 for mobile communications is installed in the folding member. A support 11 may be formed on the inner sides of the frame 10 to further secure the PCB 31. A main display screen, such as liquid crystal display (LCD) 32 is also installed in the folding member and exemplified here as being placed adjacent to the PCB 31 and to a shield 34. A main display window 36 is installed on the lower perimeter of the frame 10, through which the main display 32 can be seen. A secondary window 37 is installed on the outer surface of the folding member, through which a secondary display 33 installed in the folding member can be seen. A shield 39 is disposed adjacent to the secondary display 33.

In order to prevent the PCB 31, the main display 32, and the secondary display 32 from being damaged when the cover 20 is detached from the folding member 1, the shields 34 and 39 are preferably made of metal and are approximately 0.5 mm in thickness.

In FIG. 4, a cross sectional view of the folding member along line B-B′ in FIG. 1 shown, particularly the operational relationship of the locking element 22 and the locking aperture 23, the combination of which forms a first locking unit 100. In order to disengage the locking element 22 from the aperture 23, a user inserts his fingertip in the aperture 23 and presses on the horizontal portion of the locking element 22. By simultaneously lifting the cover 20 from the gap D formed between the cover 20 and the frame 10, the user can raise the distal edge of the cover 20 away from the frame 10, thereby fully disengaging the locking element 22 from the aperture 23.

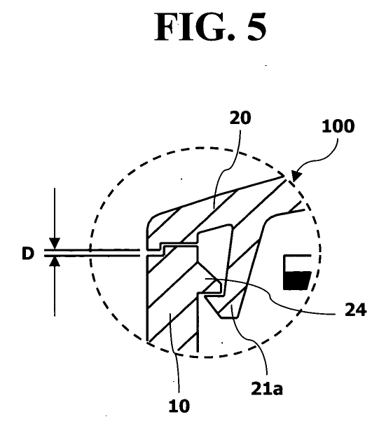

FIG. 5 illustrates an enlarged view of the encircled second locking unit 110 in FIG. 3. The second locking unit 110 comprises the locking members 21a-21d and the locking sill 24, which is formed on the inner edge of the upper perimeter of the frame 10. As exemplified in FIG. 5, locking member 21a is engaged to the locking sill 24 of the terminal member frame 10 via snap fit. After disengaging the first locking unit 100, a user is then able to insert his fingernails and/or fingertips into the gap D formed between the cover 20 and the frame 10 and disengage the locking members 21a-21d from the locking sill 24.

In order to fasten the cover 20 to the frame 10, a user aligns the cover adjacent to the frame so that locking element 22 is aligned and would engage the aperture 23. Also, the user aligns the cover 20 and/or frame 10 so that the locking members 21a-21d are aligned within the inner perimeter of the frame 10. After proper alignment, the user presses the cover 20 and frame 10 together until the locking members 21a-21d and the locking element 22 engage the locking sill 24 and locking aperture 23, respectively.

It will be apparent to those skilled in the art that various modifications and variations can be made in the present invention without departing from the spirit or scope of the invention. Therefore, the foregoing description of these embodiments of the present invention has been presented for the purposes of illustration and description. It is not intended to be exhaustive or to limit the invention to the precise form disclosed. Thus, it is intended that the present invention cover the modifications and variations of this invention provided they come within the scope of the appended claims and their equivalents. Preferred embodiments were shown in the context of folding type mobile communication terminals. In alternative embodiments, candy bar type mobile communication terminals, PDA terminals, and pagers can be substituted for the present invention. Furthermore, the present invention can be applied to cover assemblies for power supplies and peripherals for mobile communication terminals.

1. A cover assembly for a mobile communication terminal, the assembly comprising:
a frame coupled to the terminal, wherein the frame comprises:
a locking sill; and
a locking aperture; and
a cover detachably secured to the folder frame, wherein the cover comprises:
a locking element to engage the locking aperture; and
at least one locking member to engage the locking sill.

2. The assembly of claim 1, wherein the at least one locking member engages the locking sill via snap fit.

3. The assembly of claim 1, wherein the at least one locking member is formed on a lateral edge of the cover and the locking sill is formed along on an inner surface of the frame.

4. The assembly of claim 3, wherein the at least one locking member and the locking sill each comprise a protruding groove so that the protruding groove of the locking member opposes the protruding groove of the locking sill, whereby the protruding grooves of the locking member and the locking sill tightly engage each other in a locking relationship.

5. The assembly of claim 1, wherein the locking element comprises a hook portion that is inserted into the locking aperture when the cover is detachably secured to the frame.

6. The assembly of claim 5, wherein the locking aperture comprises an external cross-sectional area to allow contact with the locking element so that the locking element disengages the aperture.

7. The assembly of claim 6, wherein the locking aperture and the locking element are formed on corresponding distal ends of the frame and the cover, respectively.

8. The assembly of claim 1, further comprising a polymer.

9. A folding type mobile communication terminal comprising:
a first folding member;
a second folding member rotatably coupled to the first folding member;
a cover detachably secured to the frame, wherein the cover comprises:
a locking element formed on an end of the cover; and
a plurality of locking members formed on opposing lateral edges of the cover; and
a frame coupled to each folding member, wherein the frame comprises:
a locking sill, which is formed on an inner surface of the frame, to engage the plurality of locking members; and
a locking aperture, which is formed on an end of the frame corresponding to the end of cover where the locking element is formed, to engage the locking element.

10. The terminal of claim 9, wherein
each locking member of the plurality of locking members comprise a protruding groove; and
the locking sill comprises a protruding groove that opposes and tightly engages the protruding grooves of plurality of locking members in an locking relationship.

11. The terminal of claim 10, wherein the locking element comprises a hook portion that is inserted into the locking aperture when the cover is detachably secured to the frame.

12. The terminal of claim 11, wherein the locking aperture comprises an external cross-sectional area to allow contact with the locking element so that the locking element disengages the aperture.

13. The terminal of claim 9, wherein the frame and cover each comprise a polymer.

14. A cover assembly for a mobile communication terminal, the assembly comprising:
a frame coupled to the terminal; and
a cover detachably secured to the frame; and
a fastener for detachably securing the cover to the frame.

15. The assembly of claim 14, wherein the fastener comprises:
a locking element formed on a distal end of the cover; and
a plurality of locking members formed on opposing lateral edges of the cover;
a locking sill formed on an inner surface of the frame to engage the plurality of locking members in a snap fit configuration; and
a locking aperture formed on a corresponding distal end of the frame to engage the locking element.

16. A method of fastening a cover to a mobile communication terminal, the method comprising the steps of:
placing the cover on a frame coupled to the terminal so that a plurality of locking members formed on the cover is situated within an inner surface of the frame;
aligning a locking element formed on the cover with an aperture formed on the frame; and
pressing the cover and the frame together to snap fit the cover to the frame.

17. A method of detaching a cover to a mobile communication terminal, the method comprising the steps of:
pressing a locking element, which is formed on a distal end of the cover, through a locking aperture formed on a distal end of a frame coupled to the terminal;
lifting the distal end of the cover so as to completely disengage the locking element from the locking aperture;
lifting lateral edges of the cover;
pressing a plurality of locking members, which are formed on lateral edges of the cover, to disengage a locking sill formed on an inner surface of the frame; and
removing the cover from the frame.
